(19) United States
(12) Patent Application Publication
(10) Pub. No.: US 2003/0034942 A1
(43) Pub. Date: Feb. 20, 2003

(54) Electronic device with a display and method for controlling a display

(76) Inventors: Janto Tjandra, Singapore (SG); Ming Po Tham, Singapore (SG); Yunhua Wang, Tianjin (CN)

Correspondence Address: MOTOROLA INC, 600 NORTH US HIGHWAY 45, LIBERTYVILLE, IL, 60048-5343, US

(21) Appl. No.: 09/931,231

(22) Filed: Aug. 16, 2001

(51) Int. Cl. G09G 3/36

(52) U.S. Cl. 345/87

(57) ABSTRACT

An electronic device (1) with a Liquid Crystal Display (5) that is controllable by a processor (3). The Liquid Crystal Display (5) is capable of operating to display a plurality of color scale resolutions. There is also a Keypad (6), in communication with the processor (3), for selecting a device application from a plurality of device applications. In use, the processor (3) automatically selects one of the color scale resolutions for operation of the Liquid Crystal Display (5) and the selected color scale resolution corresponds the selected application.

### FIELD OF THE INVENTION

This invention relates to controlling color resolution of a display associated with an electronic device. The invention is particularly useful for, but not necessarily limited to, controlling color resolution of displays for portable battery powered electronic devices.

### BACKGROUND ART

Displays such as Liquid crystal displays (LCDs), or other flat panel display devices are commonly used in portable electronic devices. LCDs usually consume less power than other types of displays and are therefore typically used in battery powered electronic devices including watches, portable computers, personal digital assistants and cellular telephones.

LCDs comprise an array of cells. By controlling voltages applied to each of the LCD cells, color or gray scale resolution can be achieved. However, the steady application of a near constant voltage across an LCD cell will cause cell characteristic and performance degradation. Therefore, LCDs are typically driven by alternating the polarity of the voltages applied across each cell. Unfortunately, alternating the polarity of the voltages applied across a cell typically results in large voltage transitions causing undesirable power consumption.

Conventional implementations of applying voltages of alternating polarity typically result in large voltage transitions whenever the polarity is changed. Such large voltage transitions result in significant usage of power that is undesirable. In patent specification WO 99/12072 there is described a power saving circuit and method for driving an LCD by passively changing voltage levels on column electrodes of the LCD.

In patent specification U.S. Pat. No. 5,528,256 there is described a Power-saving circuit and method for driving a LCD. The circuit has a series of multiplexers coupled to columns of the LCD. The polarity of the driving voltages is applied to each column alternates on succeeding row drive periods. The resulting voltage is summed on a storage capacitor that averages the voltage to a median bias value. The circuit therefore saves power associated with driving the LCD.

In patent specification EP0755044 there is described a device and method for driving a LCD with pre-charge display data lines. The device has a gate line driver that sequentially applies a gate voltage to a number of gate lines. Data lines are grouped into four groups and a data line driver sequentially applies a data voltage to each data line. The device provides for a high quality image to be displayed on the LCD even if the duration of the data voltage is relatively short.

Although prior art circuits and methods reduce power consumption of the LCD there is still a need for further reduce LCD power consumption especially for portable battery powered electronic devices. In this regard, when considering color display devices, the LCD driving circuit uses unnecessary power for the displaying of low color resolution images. This is because a color LCD typically has three color cells per pixel, these being Red Green and Blue cells (RGB). When indicia, an image or an application, such as a spreadsheet, are required to be displayed, the LCD driving circuit is not controlled to correspond to the color scale resolution required (in this specification color scale resolution includes gray scale resolution). Instead, the driving power is maintained at high resolution (high LCD driving power) even when low resolution or purely gray scale indicia or images are being displayed.

### SUMMARY OF THE INVENTION

According to one aspect of the invention there is provided an electronic device comprising:

a processor;

a visual display unit controllable by the processor, the visual display unit being capable of operating to display at least two color scale resolutions; and

a user input interface, in communication with the processor, for selecting an application from a plurality of device applications, wherein, in use, the processor automatically selects one of the color scale resolutions for the visual display operation, the one of the color scale resolutions corresponding to a selected one of the device applications.

Suitably, the user input interface may provide for color scale resolutions for an application to be pre-definable by a user.

Preferably, in use, the electronic device may transform an image or indicia of an application based on the selected color scale resolution. Alternatively, in another preferred form, a dynamic color mapping/translation technique may be used.

Suitably, the display unit may have a plurality of color pixels each of the pixels comprising at least three color cells. The three color cells may be red, green and blue color emitting cells.

Preferably, the color intensity emitted from each of the color cells may be dependent upon a voltage level applied thereto.

Suitably, the user input interface may be a keypad. In an alternative form the user input interface may be a touch screen integral with the visual display unit.

Preferably, the visual display unit may be a liquid crystal display.

Suitably, the electronic device may be a cellular telephone.

According to another aspect for this invention there is provided a method for controlling a display, the method comprising the steps of:

selecting an application to be displayed on the display;

selecting automatically a color scale resolution for the application, wherein the color scale resolution corresponds to the application selected to be displayed on the display; and

displaying the application on the display with the color scale resolution selected.

Suitably, the color scale resolution for the application that is selected can be pre-definable by a user.

### BRIEF DESCRIPTION OF THE DRAWINGS

In order that the invention may be readily understood and put into practical affect, reference will now be made to a preferred embodiment as illustrated with reference to the accompanying drawings in which:

FIG. 1 is a block diagram illustrating an embodiment of an electronic device in accordance with the invention; and

FIG. 2 is flow diagram illustrating a method for controlling a display of the electronic device of FIG. 1.

### DETAILED DESCRIPTION OF THE PREFERRED EMBODIMENT OF THE INVENTION

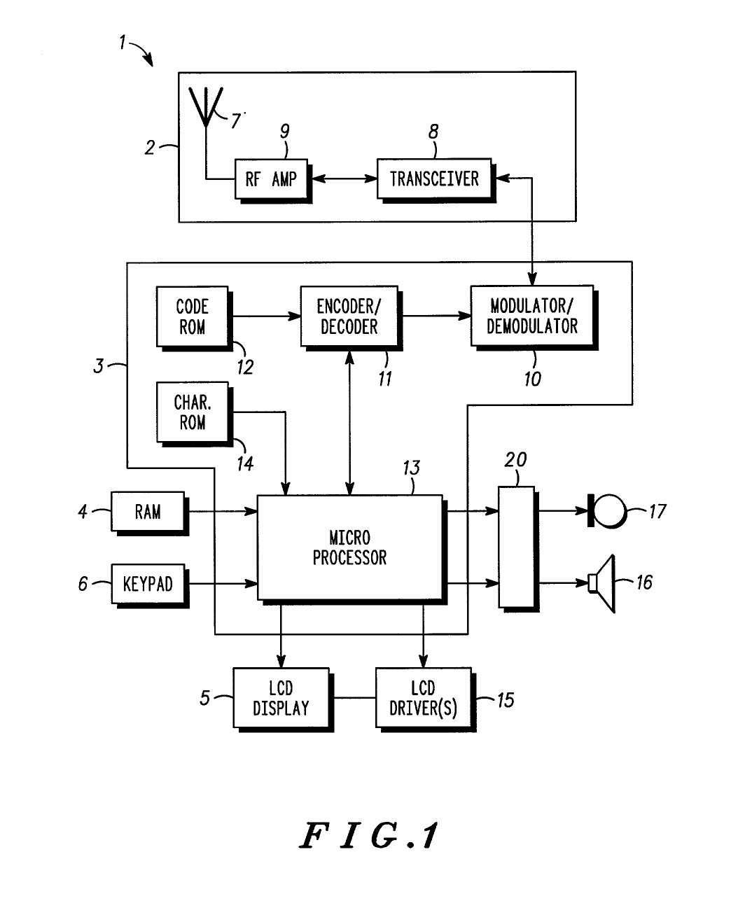

With reference to FIG. 1 there is illustrated an electronic device in the form of a cellular telephone 1. Cellular telephone 1 comprises a receiver 2 coupled to be in communication with a processor 3. A Random Access Memory 4, a visual display unit in the form of a color LCD 5 and user input interface or keypad 6 are also coupled to be in communication with processor 3.

The receiver 2 is a combined receiver and transmitter having a common antenna 7. Receiver 2 also includes a transceiver 8 coupled to antenna 7 via a radio frequency amplifier 9.

The processor 3 includes a combined modulator/demodulator 10 coupled to both transceiver 8 and an encoder/decoder 11. Encoder/decoder has an associated Read Only Memory 12 storing data for encoding and decoding voice or other signals that are transmitted or received by cellular telephone 1.

The processor 3 also includes a micro-processor 13 coupled to encoder/decoder 11 and an associated character Read Only Memory 14. Micro-processor 13 is also coupled to Random Access Memory 4, keypad 6 and LCD 5. The LCD 5 comprises a matrix of pixels, each pixel being formed from three color cells these being Red Green and Blue cells (RGB). The LCD 5 is coupled to an associated driver 15 that is controllable by micro-processor 13 and driver 15 has driving outputs for selecting and controlling all three color cells (RGB) of each pixel. Accordingly, the LCD is controllable by signals from the microprocessor 13 to thereby display numerous color scale resolutions. Further, auxiliary outputs of micro-processor 13 are coupled to a selective alert driving circuitry 20 of a speaker 16 and vibrating motor 17.

The character Read only memory 14 stores code for decoding or encoding text messages that may be received by the receiver 2 or input at the keypad 6. In this embodiment the character Read Only Memory 14 also stores operating code (OC) for micro-processor 13. The operating code (OC) is used to run device applications on the cellular telephone 1. The electronic device or cellular telephone 1 may be of the type that includes state of the art 3G technology and all personal digital assistant features. The device applications may therefore typically range from short messages, email, spreadsheets, word processing, high resolution graphic presentations and video conferencing.

As will be apparent to a person skilled in the art, a user can select an application by actuation of keys on keypad 6. For instance, one application is that of viewing a transmitted message received by receiver 2 in which the transmitted message, transmitted from a transmission source, is received by antenna 7 and then amplified by amplifier 9, filtered by receiver 8 and demodulated by the modulator/demodulator 10. The Encoder/Decoder 11 in combination with associated Read Only Memory 12 determines if the transmitted message is addressing cellular telephone 1. If it is determined that the received message is addressing cellular telephone 1, then the received message is processed by micro-processor 13, Random Access memory 4 and Read Only Memory 14.

During message processing the message content part of the message is stored in Random Access Memory 4 and micro-processor 13 sends a control signal to the alert driving circuitry 20 that activates either speaker 16, or motor 17. This therefore alerts the user that a message has been received by cellular telephone 1. The user then has the option of displaying and reading the message on LCD 5 by operation of one of one or more keys on keypad 6. Alternatively, the user may defer displaying the message until a later time.

The received message may be an email message with an attachment such as a spreadsheet or picture each having different color scale resolutions. In another mode of operation, the cellular telephone 1 may process and display a received message that may be in the form of part of a video conference with a very high color scale resolution. In yet other modes of operation, the user can select an application by actuation of keys on keypad 6. Such applications may be accessing or creating spreadsheets, word processing, importing and viewing high or low color resolution graphics, sending and receiving short messages, internet browsing and making a telephone call. Accordingly, as will be apparent to a person skilled in the art, the cellular telephone 1 may be a 2.5 G or 3 G device or it may be any electronic device with a color LCD 5.

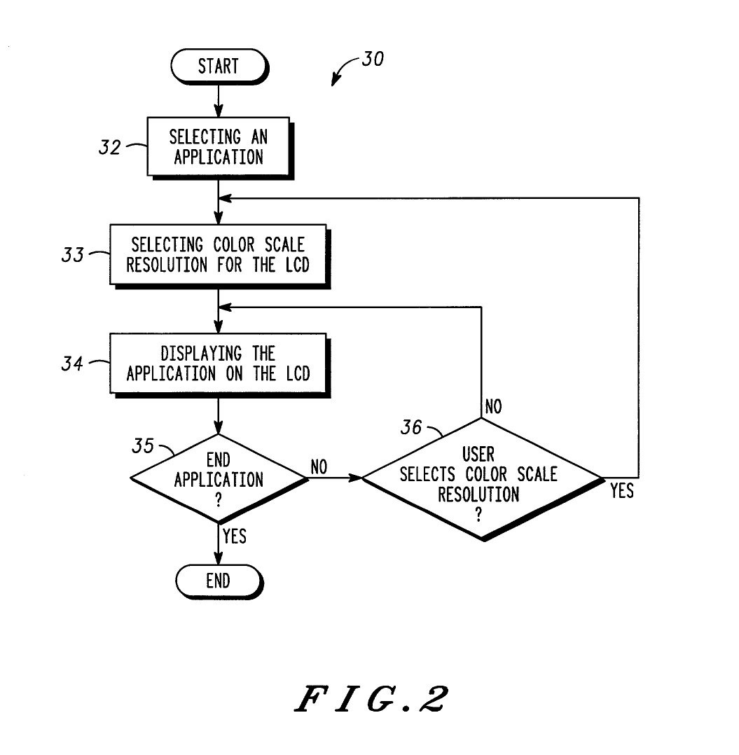

Referring to FIG. 2 there is illustrated a method 30 for controlling the LCD 5. The method 30 includes a selecting an application step 32 in which the user enters an application request by actuating one or more keys on keypad 6. The application can be virtually any application that requires to display indicia, graphics or just text on the LCD 5. After the selecting an application step 32 the processor 3 effects a selecting color scale resolution for the LCD step 33. Step 33 is effected automatically and the selected color scale resolution is dependent upon the application selected at step 32.

A displaying application on the LCD step 34 is then effected in which the application is displayed with the selected color scale resolution on the LCD 5. The selected color scale resolution is obtained by the micro-processor 13 providing a control signal to driver 15 which therefore selects which ones of the three color cells (RGB) per pixel will be driven and also what voltage or current will be supplied to the selected color cells. The method 30 will then continue to display the application at step 34 with the selected voltage or current supplied to the selected color cells until either: i) a user ends the application at a step 35 by appropriate actuation of keys on the keypad 6; or ii) a user selects a preferred color scale resolution at a step 36 again by appropriate actuation of keys on the keypad 6. If the user selects a preferred color scale resolution at a step 36, then the selecting color scale resolution for the LCD step 33 is effected followed by the displaying application on the LCD step 34. Step 34 will continue to display the application at the selected color scale resolution until the user ends the application at step 35 or selects another color scale resolution at step 36.

As will be apparent to a person skilled in the art, a user can preprogram the cellular telephone 1, by use of keypad 6, so that color scale resolutions for specific applications, images and text can be predefined. Further, during the selecting color scale resolution for the LCD step 33, the cellular telephone 1 may transform an image or indicea of an application based on the selected color scale resolution. Alternatively, a dynamic color mapping/translation technique may be used.

The present invention may advantageously reduce power consumption associated with color LCDs and other display devices. This is achieved by selectively altering the color scale resolutions for different applications displayed on the LCD 5, whereby the processor 3 selects a color scale resolution corresponding to a selected one of the cellular telephone applications to be displayed on the LCD 5. Hence, for instance, if the application to be displayed is alphanumeric then an eight bit gray scale (color scale resolution) could be automatically selected at step 33, therefore the LCD 5 would operate in a lower power mode. Alternatively, if the application to be displayed is a detailed color image then a 260,000 color scale resolution could be automatically selected at step 33, therefore the LCD 5 would operate in a higher power mode.

Although the invention has been described with reference to a preferred embodiment it is to be understood that the invention is not restricted to the particular embodiment described herein. For example, although the electronic device may be any electronic device such as a computer, personal digital assistant, pager or any device that has a color display. Further, the keypad 6 may be a touch screen integral with the LCD 5

We claim:

1. An electronic device comprising:
a processor;
a visual display unit controllable by said processor, said visual display unit being capable of operating to display at least two color scale resolutions; and
a user input interface, in communication with said processor, for selecting an application from a plurality of device applications, wherein, in use, said processor automatically selects one of said color scale resolutions for said visual display operation, said one of said color scale resolutions corresponding to a selected one of said device applications.

2. An electronic device as claimed in claim 1, wherein said user input interface provides for color scale resolutions for an application to be pre-definable by a user.

3. An electronic device as claimed in claim 1, wherein, in use, said electronic device transforms an image or indicia of an application based on the selected color scale resolution.

4. An electronic device as claimed in claim 1, wherein said display unit has a plurality of color pixels each of said pixels comprising at least three color cells.

5. An electronic device as claimed in claim 1, wherein color intensity emitted from each of the color cells is dependent upon a voltage level applied thereto.

6. An electronic device as claimed in claim 1, wherein said user input interface is a keypad.

7. An electronic device as claimed in claim 1, wherein said user input interface is a touch screen integral with said visual display unit.

8. An electronic device as claimed in claim 1, wherein said visual display unit is a liquid crystal display.

9. A method for controlling a display, said method comprising the steps of:
selecting an application to be displayed on said display;
selecting automatically a color scale resolution for said application, wherein said color scale resolution corresponds to said application selected to be displayed on said display; and
displaying said application on said display with said color scale resolution selected.

10. A method for controlling a display as claimed in claim 9, wherein said color scale resolution for said application that is selected is pre-definable by a user.
